(19) United States
(12) Patent Application Publication
(10) Pub. No.: US 2025/0002724 A1
(43) Pub. Date: Jan. 2, 2025

(54) METHOD FOR MANUFACTURING AN OPTICAL MATERIAL AND COMPOSITION USED IN THIS METHOD

(71) Applicant: MITSUI CHEMICALS, INC., Chuo-ku, Tokyo (JP)

(72) Inventors: Andrea VECCHIONE, Ravenna (IT); Roberto FORESTIERI, Ravenna (IT); Francesco MARIANI, Ravenna (IT)

(73) Assignee: MITSUI CHEMICALS, INC., Chuo-ku, Tokyo (JP)

(21) Appl. No.: 18/262,744

(22) PCT Filed: Apr. 18, 2022
(86) PCT No.: PCT/JP2022/018018

§ 371 Date: Jul. 25, 2023

(30) Foreign Application Priority Data
Apr. 19, 2021 (IT) 102021000009824

(51) Int. Cl. C09B 67/20; C08F 122/00; C08K 5/00; C09B 47/04; G02B 1/04

(52) U.S. Cl. CPC C09B 67/0064; C08F 122/00; C08K 5/0091; C09B 47/04; G02B 1/041

(57) ABSTRACT

The present invention relates to a method for manufacturing an optical material comprising the following steps: i) mixing: A. at least one polymerizable component comprising at least one diallyl compound, B. at least one UV and/or HEV light-absorbing agent, C. at least one tetraazaporphyrin dye, D. at least one peroxydicarbonate esters as radical polymerization initiator, to obtain a polymerizable composition; ii) casting the polymerizable composition in at least one mould; iii) curing the polymerizable composition to obtain a solid polymerized molded element and extracting the solid polymerized molded element from the mould; iv) heat treating the solid polymerized molded element at a temperature within the range of from 50 degree C. to 150 degree C. to obtain the optical material.

### TECHNICAL FIELD

The present invention relates to a method for manufacturing an optical material and a composition used therefor.

### BACKGROUND ART

Polymeric materials, such as plastics, have been developed as alternatives and replacements for silica based inorganic glass in applications such as optical lenses, fiber optics, windows and automotive, nautical and aviation transparencies as well as transparent elements for electronic devices. These polymeric materials, also known as organic glasses, can provide advantages relative to glass, including, shatter resistance, lighter weight for a given application, ease of molding and ease of dyeing. Representative examples of such polymeric materials include allyl polymers such as the polymers obtained from the polymerization of diethylene glycol bisallyl carbonate monomers. Poly(allyl carbonate) polymers, for example, are particularly suitable for producing organic glasses or transparent coating films, in particular ophthalmic lenses, or elements of optical devices.

Light that reaches and enters the human eye is divided into visible light, comprising wavelengths from about 380 to 780 nm, and non-visible light, which includes light in the ultraviolet range (UV-A and UV-B light from about 280 to 380 nm) and the infrared range (Near IR light from about 780 to 1400 nm).

LV light is known to be harmful to the human eye. In particular, it can accelerate ocular ageing which can lead to an early cataract or to other disorders such as photokeratitis. Blue light, also known as high-energy visible (HEV) light, corresponds to visible light in the blue-violet range between 380 nm and 500 nm. Although HEV light is a lower energy light compared to LV-A radiation, it nevertheless penetrates deeply into the eye causing retinal damage such macular degeneration.

In many applications it is therefore desired that organic glasses, such as spectacle lenses and sunglass lenses, have LV and HEV light-blocking properties, namely the organic glasses should absorb light in the LV and HEV wavelength range of 280 nm to 500 nm.

To produce organic glasses having LV and HEV light-absorbing properties, light-absorbing compounds capable of absorbing LV and HEV radiation (hereinafter, LV-absorbers and HEV absorbers, respectively) can be incorporated in the liquid formulation used to manufacture the organic glass, i.e. the polymerizable composition before polymerization. The incorporation of the LV and HEV absorbers in the amounts needed to shield UV and HEV light, however, brings about an undesired yellowness of the organic glass, the intensity of which increases with the increase of the amounts of UV absorber.

Yellowness represent a serious issue in the manufacturing of colour-neutral, i.e. colourless, organic glasses as it makes the appearance of the glass unattractive. Moreover, yellowness also affects the colour perception by the observer and eventually lower the light transmittance of the glass.

In order to overcome the above issue and produce transparent, colour-neutral optical materials, it is known in the state of the art to bleach the polymer material by incorporating colouring agents into the polymerizable composition. The colouring agents generally comprises at least one colouring compound (i.e. a pigment or organic dye) having a blue colour, such as a compound having a main absorption peak within the range 570 nm to 600 nm, that interacts with the incident light radiation to compensate the yellow colour brought about by the UV absorbing compounds. This bleaching effect makes the colour of the optical material be perceived as neutral by a humans eye.

Pigments are colouring agents substantially insoluble in the polymerizable composition that can be effectively used as bleaching agents to reduce yellowness of an optical material. Moreover, they have the advantage of withstanding the oxidative action of the radical polymerization initiators. Pigment particles, however, have the tendency to aggregate in the polymerizable composition forming colloids, which may interfere with the incident light radiation (so-called Tyndall effect) producing an undesired increase of the haze value of the polymerized material.

Compared to pigments, organic dyes have the advantage of correcting yellowness without significantly increasing the haze of the optical material. Indeed, since dyes are soluble and easily dispersible in the polymerizable composition, they minimize the diffusion of the incident light within the polymerized products thus keeping haze low. However, it is known that organic dyes are decomposed during the polymerization reaction in the presence of certain radical polymerization initiators, such as alkyl peroxide compounds (e.g. isopropyl peroxydicarbonate (IPP) and isopropyl-sec-butyl peroxydicarbonate) and aroyl peroxide compounds (e.g. dibenzoyl peroxide) which are commonly used initiators for the polymerization of allyl monomers. The degradation of dyes during the curing step reduces their effectiveness as bleaching agents of the optical material, leading to unpredictable optical characteristics and not reproducible colour-neutral features of the polymerized product.

An important class of dyes used in the manufacturing of organic glasses are azaporphyrin dyes, especially tetraazaporphyrin (TAP) dyes. TAP dyes have a main absorption peak within the range of from 565 nm to 605 nm. Such light absorption properties make TAP dyes particularly suitable also as additive to impart antiglare properties to organic glasses as they selectively shield dazzling wavelengths rays.

TAP dyes are mainly used as antiglare additives in the form of coatings that are applied on the surface of a polymerized optical material. As additives that are incorporated in the mass of the polymerizable composition of the optical material, they have in fact limited application (for example, in polyurethane lenses) as their effectiveness is markedly affected by the polymerization conditions. In particular, the light blocking function of TAP dyes is strongly influenced by certain peroxide initiators. U.S. Pat. No. 8,415,413 B2, for example, discloses the use of mild radical initiators different from peroxydicarbonates to ensure that absorbing properties of an azaporphyrin dye withstand polymerization process. Among the alternative peroxides proposed, peroxyesters and perketals having a 10 hour-half-life temperature of 90 degree C. to 110 degree C. are disclosed. Comparative examples 1 and 3 of U.S. Pat. No. 8,415,413 B2 show that when a TAP dye is used in the presence of a peroxydicarbonate initiator such as diisopropyl peroxydicarbonate or di(2-ethylhexyl) peroxydicarbonate the polymerized product comprising diethylene glycol bisallyl carbonate as base lens material has scarce light absorbing capability within the range 565 nm to 605 nm due to decomposition of the TAP dye.

Polymerization in the presence of mild radical polymerization initiators as suggested in U.S. Pat. No. 8,415,413 B2, however, requires higher curing temperatures in order to properly generate free radicals capable of completely curing the polymerizable composition. Curing at higher temperatures, in turn, results in polymerized materials that are brittle and prone to break or be damaged during the demoulding step of the cured product. In addition, in the presence of mild peroxide initiators longer curing cycles are needed to reach a satisfactory polymerization level of the lenses, thus decreasing the productivity of the manufacturing process.

An alternative way to prevent decomposition of light absorbing additives during polymerization of allyl monomers is disclosed in WO 2018029249 A1. This application discloses light absorbing additives that are encapsulated in polymer-based nanoparticles that protect the additive from degradation caused by peroxide polymerization initiators. Encapsulation of the light-absorbing additive, however, is a time consuming and costly operation. Moreover, encapsulated light-absorbing additives may negatively influence the haze of the polymerized material depending on the size of the nanoparticles and their possible tendency to aggregate in the polymerizable composition.

### SUMMARY OF INVENTION

### Problem that the Invention is to Solve

In view of the above-described state of the art, Applicants have faced the problem of overcoming or at least ameliorate some of the drawbacks set out above. Particularly, a scope of the present invention is to provide a method and a composition to produce an optical material comprising an allyl polymer, particularly suitable for use as an ophthalmic lens, that is transparent, colourless (i.e. colour-neutral), has minimal haze and exhibit UV- and/or HEV-light blocking function. These optical properties have to be achieved without affecting, as much as possible, other favourable properties of the plastic materials, such as hardness, impact strength and resistance to abrasion.

Another technical problem faced by the Applicant is to provide a method and a composition to produce an optical material having antiglare properties that are imparted by coloring agents, such as azaporphyrin dyes, that are added into the mass of a polymerizable composition containing strong peroxide radical polymerization initiators.

### Means for Solving the Problem

The present invention is based on the surprising observation that the loss of the light-blocking functions of the tetraazaporphyrin dyes which occurs upon polymerization of an allyl-based polymerizable composition in the presence of strong peroxide initiators, such as peroxycarbonate ester compounds, can be recovered, at least partly, if the polymerized product is kept at a moderate temperature (e.g. between 20 degree C. and 140 degree C.) for sufficient time.

Based on this finding, a TAP dye can be effectively used as bleaching agent in allyl-based polymerizable compositions in the presence of a strong peroxide initiator to correct yellowness caused by UV and HEV absorbers by simply thermally treating the polymerized molded element after the curing step until the TAP dye recovers its light absorbing function, at least partly. The recovery of the light-absorbing function can be monitored, for example, by determining the Yellowness Index value or the transmittance value at the characterizing wavelength (light cut-off) of the TAP dye on the optical material before and after the post-curing heat treatment.

The use of TAP dyes in combination with strongly oxidative peroxide initiators allows to obtain clear optical materials having UV and/or HEV blocking function and low levels of haze. The optical material can also be obtained in a substantially colour-neutral form. These optical properties are obtained without resorting to the use of mild polymerization initiators or to encapsulation of the additives as taught in the state of the art thus avoiding their associated drawbacks. Additionally, since strongly oxidizing peroxide initiators are used, the mechanical properties of the optical material, such as hardness, impact strength and resistance to abrasion, are excellent.

Moreover, since the aforementioned behaviour of the TAP dyes upon heating has been observed for TAP dyes having different chemical compositions, TAP dyes having different chemical compositions and light absorbing characteristics can be used as bleaching agent according to the need.

Additionally, when incorporated in the polymerizable composition at relatively high concentration rates (e.g. 3 to 300 ppm), TAP dyes allow to produce optical materials having antiglare properties without applying superficial coatings.

Without wishing to be bound to any theory, the experimental evidences gathered by the inventors seem to indicate that the loss of the light-blocking function observed in the state of the art is actually due to a temporary deactivation of the TAP dye caused by its interaction with peroxide initiator derivatives such as radical species deriving from the thermal degradation of the peroxide initiators rather than to an irreversible structural degradation of the dye molecule. The deactivating interaction can be easily and permanently reversed by a heat treatment of the polymerized molded element obtained after the curing step, which takes away the peroxide derivative interacting with the dye molecules.

Therefore, according to a first aspect the present invention relates to a method for manufacturing an optical material comprising the following steps:
i) mixing:
A. at least one polymerizable component comprising at least one diallyl compound,
B. at least one UV and/or HEV light-absorbing agent,
C. at least one tetraazaporphyrin dye,
D. at least one peroxydicarbonate ester as radical polymerization initiator,
to obtain a polymerizable composition;
   ii) casting the polymerizable composition in at least one mould;
   iii) curing the polymerizable composition to obtain a solid polymerized molded element and extracting the solid polymerized molded element from the mould;
   iv) heat treating the solid polymerized molded element at a temperature within the range of from 50 degree C. to 150 degree C. to obtain the optical material.

According to a second aspect the present invention relates to a polymerizable liquid composition for the manufacturing of an optical material comprising:
A. at least one polymerizable component comprising at least one diallyl compound,
B. at least one UV and/or HEV light-absorbing agent,
C. at least one tetraazaporphyrin dye,
D. at least one peroxydicarbonate ester as radical polymerization initiator,
wherein the tetraazaporphyrin dye has the following formula T1

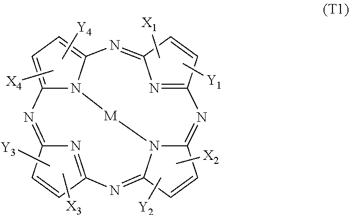

wherein:
X¹ to X⁴ each individually represents a tertiary saturated alkyl group having 6 or less carbon atoms;
Y¹ to Y⁴ each individually represents a hydrogen atom, a substituted or unsubstituted aryl group having from 6 to 20 carbon atoms, a substituted or unsubstituted aryloxy group, or a substituted or unsubstituted haloaryl group having from 6 to 20 carbon atoms;
M represents a divalent metal atom, a trivalent metal atom having one substituent, a tetravalent metal atom having two substituents, or an oxy-metal atom; and
   wherein the tetraazaporphyrin dye is present in an amount of less than 300 ppm.

Further characteristics of the present invention are illustrated in the dependent claims annexed to the present description.

The compositions of the present invention can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

As used herein, the articles “a”, “an” and “the” should be read to include one or at least one and the singular also includes the plural, unless it is obvious that it is meant otherwise. This is done merely for convenience and to give a general sense of the disclosure.

Other than in the operating examples, or where otherwise indicated, all numbers expressing quantities of ingredients, reaction conditions, and so forth used in the specification and claims are to be understood as modified in all instances by the term “about”.

The expressions “UV-cut” and “HEV-cut” as used herein represent the highest wavelength in the UV region and HEV region, respectively, for which the light transmittance of an optical material is lower than 1% as measured in accordance with ASTM D 1003.

The expressions “light cut-off” as used herein represents the value of transmittance, at a given wavelength WL, measured on a moulded article in the form of a flat plate having a thickness of 2 mm, if not specified otherwise, and expressed as percentage according to the following formula:

Light Cut Off_{(WL)}%=100(%)−Transmittance (%) at the wavelength WL.

### BRIEF DESCRIPTION OF DRAWINGS

FIG. 1 shows the UV Vis spectra in transmittance of optical materials C1 to C6 prepared according to the invention.

FIG. 2 shows the variation of the Yellow Index (ASTM D1925) as a function of the time of exposure to light of the polymerizable composition before curing.

### BEST MODE FOR CARRYING OUT THE INVENTION

The first step of the method of the present invention provides for the preparation of a polymerizable liquid composition comprising a diallyl compound as polymerizable component, at least one UV and/or HEV light-absorbing agent, at least one tetraazaporphyrin dye and at least one radical polymerization initiator.

### Polymerizable Component (A)

The polymerizable component can be selected among a wide variety of diallyl compounds, which may include monomers, oligomers and/or prepolymers, having at least two allyl groups as polymerizable functional groups.

The polymerizable component may comprise, for example, compounds containing two or more ethylenically unsaturated groups, such as diallyl esters, diallyl carbonate, diallyl phtalate, allyl (meth)acrylate, vinyl meth(acrylate).

In an embodiment, the polymerizable component is selected from: diethylene glycol bis(allyl carbonate), ethylene glycol bis(allyl carbonate), oligomers of diethylene glycol bis(allyl carbonate), oligomers of ethylene glycol bis(allyl carbonate), bisphenol A bis(allyl carbonate), diallylphthalates such as diallyl phthalate, diallyl isophthalate, diallyl terephthalate, diallyl orthophthalate and mixtures thereof.

In an embodiment, the polymerizable component (A) it can be represented as a compound including two or more allyloxycarbonyl groups according to the following formula (1)

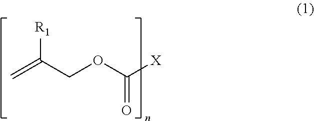

wherein, in the formula, n is an integer of 2 to 6, R₁ indicates a hydrogen atom or a methyl group, a plurality of present R₁'s may be the same or different, X is a divalent to hexavalent organic group a derived from a linear or branched aliphatic polyol having 3 to 12 carbon atoms which may have an oxygen atom, a divalent to hexavalent organic group b derived from an alicyclic polyol having 5 to 16 carbon atoms which may have an oxygen atom, or a divalent to hexavalent organic group c derived from an aromatic compound having 6 to 12 carbon atoms, and the organic group a or the organic group b forms an allyl carbonate group by bonding to an allyloxycarbonyl group via an oxygen atom derived from a hydroxyl group.

These polyols normally include 2 to 6 hydroxyl groups in the molecule, and it is possible for these polyols to include 2 to 4 hydroxyl groups in the molecule, which is preferable.

Examples of the aliphatic polyol al include diethylene glycol, dipropylene glycol, triethylene glycol, tetraethylene glycol, 1,3-propanediol, 1,4-butanediol, 1,5-pentanediol, 1,6-hexanediol, neopentyl glycol, 3-methyl-1,5-pentanediol, 2-methyl-2-ethyl-1,3-propanediol, 2,2-diethyl-1,3-propanediol, 2,2,4-trimethyl-1,3-pentanediol, glycerol, trimethylolpropane, tris(hydroxyethyl) isocyanurate, pentaerythritol, dipentaerythritol, and the like.

Examples of the alicyclic polyol b1 include 1,4-dimethylolcyclohexane, 4,8-bis(hydroxymethyl)-[5.2.1.0^{2,6}]tricyclodecane, and the like.

Examples of the aromatic compound cl include benzene, toluene, xylene, naphthalene, and the like.

Specific examples of the compound including two or more allyloxycarbonyl groups include an allyl carbonate polymerizable compound (A1), an allyl ester polymerizable compound (A2), and a polymerizable compound (A3) including at least one of an allyl carbonate group and an allyl ester group.

It is possible for the compound (A) including two or more allyloxycarbonyl groups to include an oligomer thereof. A compound including two or more allyloxycarbonyl groups is a liquid product at room temperature, the viscosity measured at 25 degree C. is 10 to 1000 cSt, and it is possible to change the oligomer content in a wide range, for example, 0 to approximately 80% by weight.

### Allyl Carbonate Polymerizable Compound (A1)

The allyl carbonate polymerizable compound (A1) can be represented by Formula (2)

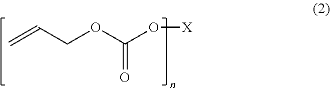

wherein, in Formula (2), X represents a divalent to hexavalent group derived from a linear or branched aliphatic polyol having 3 to 12 carbon atoms or a divalent to hexavalent group derived from an alicyclic polyol having 5 to 16 carbon atoms, and n represents an integer of 2 to 6.

The allyl carbonate polymerizable compound (A1) of Formula (II) may include an oligomer thereof. The oligomer is a poly(allyl carbonate) in which two or more molecules of a polyol are linked via a carbonate group produced by transesterification reaction of allyl carbonate produced in the production step and a polyol.

The allyl carbonate polymerizable compound is a poly(allyl carbonate) compound of a linear or branched aliphatic polyol having 3 to 12 carbon atoms. A poly(allyl carbonate) compound of an alicyclic polyol having 5 to 16 carbon atoms in the molecule is also suitable for this purpose. These polyols usually have 2 to 6 hydroxyl groups in the molecule and it is possible for these polyols to have 2 to 4 hydroxyl groups in the molecule, which is preferable. It is also possible to use a mixed poly(allyl carbonate) compound, that is, a compound which is derived from at least two kinds of polyols and which can be obtained by mechanical mixing of the respective polyol poly(allyl carbonate) compounds, or a compound obtained directly by a chemical reaction starting from a mixture of polyols and diallyl carbonate.

Finally, it is possible for all these poly(allyl carbonate) compounds to be in the form of monomers or mixtures of monomers and oligomers. Generally, the allyl carbonate polymerizable compound is a liquid product at room temperature, the viscosity measured at 25 degree C. is 10 to 1000 cSt, and it is possible to change the oligomer content in a wide range, for example, 0 to approximately 80% by weight.

Specific examples of the polyols forming X in General Formula (2) include diethylene glycol, dipropylene glycol, triethylene glycol, tetraethylene glycol, 1,3-propanediol, 1,4-butanediol, 1,5-pentanediol, 1,6-hexanediol, neopentyl glycol, 3-methyl-1,5-pentanediol, 2-methyl-2-ethyl-1,3-propanediol, 2,2-diethyl-1,3-propanediol, 2,2,4-trimethyl-1,3-pentanediol, 1,4-dimethylolcyclohexane, 4,8-bis(hydroxymethyl)-[5.2.1.0^{2,6}]tricyclodecane, glycerol, trimethylolpropane, tris(hydroxyethyl) isocyanurate, pentaerythritol, diglycerol, ditrimethylolpropane, dipentaerythritol, and the like.

Accordingly, examples of the allyl carbonate compounds include at least one kind selected from bis(allyl carbonate) compounds of at least one kind of diol selected from diethylene glycol, dipropylene glycol, triethylene glycol, tetraethylene glycol, 1,3-propanediol, 1,4-butanediol, 1,5-pentanediol, 1,6-hexanediol, neopentyl glycol, 3-methyl-1,5-pentanediol, 2-methyl-2-ethyl-1,3-propanediol, 2,2-diethyl-1,3-propanediol, 2,2,4-trimethyl-1,3-pentanediol, 1,4-dimethylolcyclohexane, and 4,8-bis(hydroxymethyl)-[5.2.1.0^{2,6}] tricyclodecane; tris (allyl carbonate) compounds of at least one kind of triol selected from glycerol, trimethylolpropane, and tris(hydroxyethyl) isocyanurate; tetra(allyl carbonate) compounds of at least one kind of tetraol selected from pentaerythritol, diglycerol, and ditrimethylol propane; dipentaerythritol hexa (allyl carbonate) compounds; and a mixed poly(allyl carbonate) compound of at least two kinds of compounds selected from the diols, the triols, the tetraols, and the dipentaerythritol.

The “bis(allyl carbonate) of a mixture of at least two kinds of diols” is, for example, obtained as a mixture of the following monomer components and oligomer components in a case where the diols are diethylene glycol and neopentyl glycol:
monomer component:
(1) diethylene glycol bis(allyl carbonate);
(2) neopentyl glycol bis(allyl carbonate);
oligomer component:
(3) oligomer including only hydrocarbons (and ethers) derived from diethylene glycol (a compound having a structure in which two hydroxyl groups of a compound in which diethylene glycol is linearly oligomerized via a carbonate bond are replaced with allyl carbonate groups);
(4) oligomer including only hydrocarbons derived from neopentyl glycol (a compound having a structure in which two hydroxyl groups of a compound in which neopentyl glycol is linearly oligomerized via a carbonate bond are replaced with allyl carbonate groups);
(5) complex oligomer including both hydrocarbons (and ethers) derived from diethylene glycol and a hydrocarbon derived from neopentylglycol in the same molecule (a compound having a structure in which two hydroxyl groups of a compound in which diethylene glycol and neopentyl glycol are linearly oligomerized in an arbitrary sequence in the same molecule via a carbonate bond are replaced with allyl carbonate groups).

The following are preferable examples of the allyl carbonate polymerizable compound (A1) suitable for the purposes of the present invention:
(i) Mixture with diethylene glycol bis(allyl carbonate) and oligomers thereof, where
diethylene glycol bis (allyl carbonate) can be defined by Formula (I)

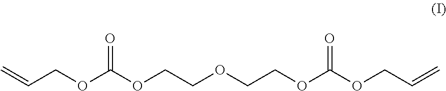 [SMILES: C=CCOC(=O)OCCOCCOC(=O)OCC=C]

In addition, it is possible to define an oligomer of diethylene glycol bis(allyl carbonate) by Formula (II)

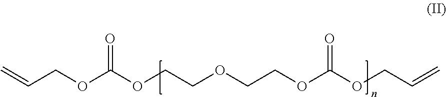

wherein, in the formula (II), n is equal to or more than 1 and equal to or less than 10.

It is possible to manufacture compound (I) by reacting diethylene glycol bis (chloroformate) with allyl alcohol as described in, for example, “Encyclopedia of Chemical Technology”, Kirk-Othmer, Third Edition, Volume 2, pages 111-112. It is possible to easily produce mixtures of diethylene glycol-bis(allyl carbonate) (Formula (I)) and an oligomer (Formula (II)) thereof by ester replacement between diallyl carbonate and diethylene glycol in the presence of a basic catalyst, for example, as described in EP 35304. These mixtures usually include up to approximately 80% by weight of oligomers;

(ii) Mixture of bis(allyl carbonate) compound of a mixture of diethylene glycol and neopentyl glycol with oligomers thereof

This bis (allyl carbonate) compound is the same as the bis (allyl carbonate) compound of point (i) above except that diethylene glycol is replaced with a mixture of diethylene glycol and neopentyl glycol;

(iii) Mixture of poly(allyl carbonate) compound of a mixture of diethylene glycol and tris (hydroxyethyl) isocyanurate with oligomers thereof

It is possible to obtain the poly(allyl carbonate) compound by ester replacement of a diallyl carbonate of a mixture of diethylene glycol and tris(hydroxyethyl) isocyanurate, for example, as described in U.S. Pat. No. 4,812,545.

(iv) Mixture of poly(allyl carbonate) compound of a mixture of diethylene glycol and trimethylolpropane with oligomers thereof.

This poly(allyl carbonate) compound is the same as the poly(allyl carbonate) compound of point (iii) above, except that tris(hydroxyethyl) isocyanurate is replaced with trimethylol propane.

(v) Mixture of poly(allyl carbonate) compound of a mixture of diethylene glycol and pentaerythritol with oligomers thereof.

This poly(allyl carbonate) compound is the same as the poly(allyl carbonate) compound of point (iii) above, except that tris(hydroxyethyl) isocyanurate is replaced with pentaerythritol.

(vi) Mixture of poly(allyl carbonate) compound of a mixture of diethylene glycol, neopentyl glycol, and pentaerythritol with oligomers thereof.

This poly(allyl carbonate) compound is the same as the poly(allyl carbonate) compound of point (v) above, except that diethylene glycol is replaced with two kinds of diols of diethylene glycol and neopentyl glycol.

(vii) Poly(allyl carbonate) mixture including a mixture of poly(allyl carbonate) compound of a mixture of diethylene glycol, neopentyl glycol, and pentaerythritol with oligomers thereof and a mixture of diethylene glycol bis(allyl carbonate) compound with oligomers thereof.

Allyl Ester Polymerizable Compound (A2), Polymerizable Compound (A3)

Examples of the allyl ester polymerizable compound (A2) include diallyl phthalate represented by General Formula (3) and oligomers thereof, and allyl ester compounds represented by General Formula (4) and oligomers thereof obtained by transesterification reaction of a mixture of diallyl phthalate and a polyol. Examples of the polymerizable compound (A3) include a polymerizable compound represented by General Formula (5) including at least one of an allyl ester group and an allyl carbonate group and oligomers thereof.

The polymerizable compound represented by General Formula (5) includes a mixture of an allyl ester compound, an allyl carbonate compound, and compounds having an allyl ester group and an allyl carbonate group, obtained by transesterification reaction of a mixture of dialkyl phthalate, allyl alcohol, diallyl carbonate, and a polyol.

In the present embodiment, the compounds of general Formulas (3) to (5) include regioisomers.

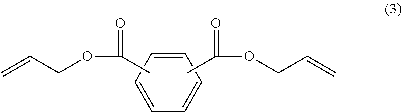

The diallyl phthalate represented by General Formula (3) is at least one kind selected from diallyl isophthalate, diallyl terephthalate, and diallyl orthophthalate.

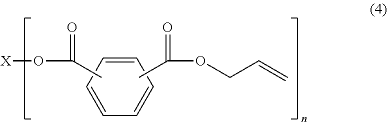

In Formula (4), X represents a divalent group derived from a linear or branched aliphatic diol having 2 to 8 carbon atoms or a trivalent to hexavalent group derived from a linear or branched aliphatic polyol having 3 to 10 carbon atoms and having 3 to 6 hydroxyl groups, and n is an integer of 2 to 6.

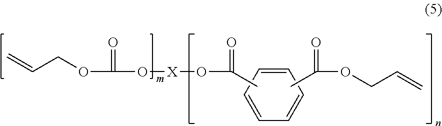

In Formula (5), X represents a divalent group derived from a linear or branched aliphatic diol having 2 to 8 carbon atoms or a trivalent to hexavalent group derived from a linear or branched aliphatic polyol having 3 to 10 carbon atoms and having 3 to 6 hydroxyl groups, m and n represent integers of 0 to 6, and the sum of m and n is an integer of 2 to 6.

Specific examples of the polyol (aliphatic diol, aliphatic polyol) forming X in Formula (4) and Formula (5) include diols of ethylene glycol, diethylene glycol, dipropylene glycol, triethylene glycol, tetraethylene glycol, 1,2-propanediol, 1,3-propanediol, 1,4-butanediol, 1,5-pentanediol, 1,6-hexanediol, neopentyl glycol, 3-methyl-1,5-pentanediol, 2-methyl-2-ethyl-1,3-propanediol, 2,2-diethyl-1,3-propanediol, 2,2,4-trimethyl-1,3-pentanediol, and 1,4-dimethylolcyclohexane; triols of glycerol and trimethylolpropane; and polyols of tris(hydroxyethyl) isocyanurate, pentaerythritol, diglycerol, ditrimethylol propane, and dipentaerythritol.

It is possible for the compounds of Formula (4) and Formula (5) to include oligomers thereof. The oligomer in Formula (4) is produced by transesterification reaction of an allyl ester compound produced in a production step and a polyol. The oligomer in Formula (5) is produced by transesterification reaction of the allyl ester compound or the allyl carbonate compound produced in the production step and the polyol.

Accordingly, the allyl ester polymerizable compound (A2) or the polymerizable compound (A3) includes at least one kind selected from, for example, a diallyl phthalate compound selected from diallyl isophthalate, diallyl terephthalate, and diallyl orthophthalate; diallyl ester compounds and oligomers thereof obtained by transesterification reaction between the diallyl phthalate compound and a mixture of at least one kind of diol selected from ethylene glycol, diethylene glycol, dipropylene glycol, triethylene glycol, tetraethylene glycol, 1,2-propanediol, 1,3-propanediol, 1,4-butanediol, 1,5-pentanediol, 1,6-hexanediol, neopentyl glycol, 3-methyl-1,5-pentanediol, 2-methyl-2-ethyl-1,3-propanediol, 2,2-diethyl-1,3-propanediol, 2,2,4-trimethyl-1,3-pentanediol, 1,4-dimethylolcyclohexane, and the like; a polyallyl ester compound and an oligomer thereof obtained by transesterification reaction between the diallyl phthalate and a mixture of at least one kind of polyol selected from triols of glycerol and trimethylolpropane, tris(hydroxyethyl) isocyanurate, pentaerythritol, diglycerol, ditrimethylol propane, dipentaerythritol, and the like; and an allyl ester compound, an allyl carbonate compound, a compound having an allyl carbonate group and an allyl ester group, and oligomers thereof, obtained by transesterification reaction of a mixture of at least one kind of dialkyl phthalate having 1 to 3 carbon atoms selected from dimethyl isophthalate, dimethyl terephthalate, dimethyl orthophthalate, diethyl isophthalate, diethyl terephthalate, diethyl orthophthalate, dipropyl isophthalate, dipropyl terephthalate, and dipropyl orthophthalate, an allyl alcohol, diallyl carbonate, and the diol or polyol described above.

More specifically, the allyl ester polymerizable compound (A2) or the polymerizable compound (A3) preferably includes at least one kind selected from (i) a mixture of diallyl terephthalate and a diethylene glycol bis (allyl carbonate) compound at 30% by weight with respect to the diallyl terephthalate and an oligomer thereof; (ii) an allyl ester compound obtained by transesterification reaction of a mixture of diallyl terephthalate and propylene glycol; (iii) a mixture of the allyl ester compound of (ii) and a diethylene glycol bis(allyl carbonate) compound at 20% by weight with respect to the allyl ester compound and an oligomer thereof; (iv) a mixture of an allyl ester compound, an allyl carbonate compound, and a compound having an allyl ester group and an allyl carbonate group, obtained by transesterification reaction of a mixture of dimethyl terephthalate, allyl alcohol, diallyl carbonate, and diethylene glycol, and (v) a mixture of the mixture obtained in (iv) and a diethylene glycol bis (allyl carbonate) compound at 10% by weight with respect to the mixture and an oligomer thereof.

The following are preferable examples of the allyl ester polymerizable compound (A2) or the polymerizable compound (A3) suitable for the purposes of the present invention: a mixture of an allyl ester compound, an allyl carbonate compound, and a compound having an allyl ester group and an allyl carbonate group, obtained by transesterification reaction of a mixture of dimethyl terephthalate, allyl alcohol, diallyl carbonate, and diethylene glycol.

It is possible for the allyl ester polymerizable compound (A2) or the polymerizable compound (A3) described above to be defined by the Formulas (III) to (V), the diallyl terephthalate of Formula (III) is the main component thereof, and each includes an oligomer obtained by transesterification reaction with a polyol.

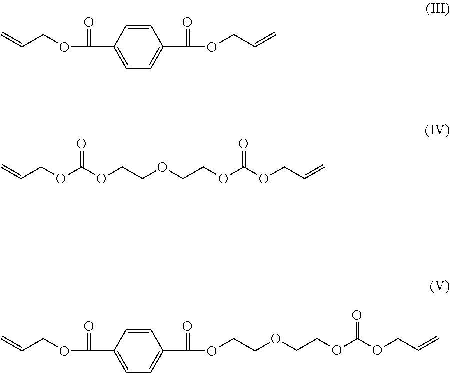

According to the present invention, it is possible to select the compound (A) including two or more allyloxycarbonyl groups as a mixture of the allyl ester polymerizable compound (A2) and/or the polymerizable compound (A3) and oligomers thereof with the allyl carbonate polymerizable compound (A1) and an oligomer thereof.

### Polymerizable Comonomers

The polymerizable composition may also comprise a second monomer or oligomer that is capable of polymerizing with the allyl monomer or oligomer described above. Examples of a suitable second monomer include: aromatic vinyl compounds such as styrene, alpha-methylstyrene, vinyltoluene, chlorostyrene, chloromethylstyrene and divinylbenzene; alkyl mono(meth)acrylates such as methyl (meth)acrylate, n-butyl (meth)acrylate, n-hexyl (meth)acrylate, cyclohexyl (meth)acrylate, 2-ethylhexyl (meth)acrylate, methoxydiethylene glycol (meth)acrylate, methoxypolyethylene glycol (meth)acrylate, 3-chloro-2-hydroxypropyl (meth)acrylate, stearyl (meth)acrylate, lauryl (meth)acrylate, phenyl (meth)acrylate, glycidyl (meth)acrylate and benzyl (meth)acrylate, 2-hydroxyethyl (meth)acrylate, 2-hydroxypropyl (meth)acrylate, 3-hydroxypropyl (meth)acrylate, 3-phenoxy-2-hydroxypropyl (meth)acrylate and 4-hydroxybutyl (meth)acrylate; di(meth)acrylates such as ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexanediol di(meth)acrylate, neopentyl glycol di(meth)acrylate, polypropylene glycol di(meth)acrylate, 2-hydroxy-1,3-di(meth)acryloxypropane, 2,2-bis[4-((meth)acryloxyethoxy)phenyl]propane, 2,2-bis[4-((meth)acryloxydiethoxy)phenyl]propane and 2,2-bis[4-((meth)-acryloxypolyethoxy)phenyl]propane; tri(meth)acrylates such as trimethylolpropane tri(meth)acrylate and tetramethylolmethane tri(meth)acrylate; tetra(meth)acrylates such as tetramethylolmethane tetra(meth)acrylate. These monomers may be used singly or in combination of two or more. In the above description, “(meth)acrylate” means “methacrylate” or “acrylate”, and “(meth)acryloxy” means “methacryloxy” or “acryloxy”.

The amount of the second monomer or oligomer in the polymerizable composition according to the present invention may be from 1% to 80% by weight, in particular from 1 to 50% by weight, more particularly from 2% to 20% by weight, even more particularly from 3% to 10% by weight, based on the total weight of the polymerizable composition.

### Uv and HEV Light-Absorbing Agent (B)

The LV and/or HEV light-absorbing agent comprises one or more compounds capable of absorbing LV wavelengths, namely below 380 nm (UV-absorber), and/or HEV wavelengths, namely within the range of from 380 nm to 500 nm (HEV-absorber).

In an embodiment, the LV and/or HEV light-absorbing agent comprises at least one LV absorber compound. Preferably, the UV absorber compound is capable of imparting a LV-cut to the optical material. Preferably, the LV absorber is chosen so that the optical material obtained from the polymerizable composition has a LV-cut of at least 380 nm.

In an embodiment, the LV and/or HEV light-absorbing agent comprises at least one HEV-absorber, i.e. it comprises at least one compound capable of absorbing visible light in the blue-violet range between 380 nm and 500 nm. This absorption may be specific, with a selective absorber having an absorption peak in the range between 380 nm and 500 nm. This absorption may be also non-specific, but linked to the effect of a broad band of absorption of a LV absorber. In other words, in certain cases a single light-absorbing compound may be used to provide both LV-cut and HEV-cut.

In another embodiment, the LV and/or HEV light-absorbing agent comprises a mixture of at least one LV-absorber and at least one HEV-absorber.

As UV-absorbers and HEV-absorbers any compound among those conventionally employed in the state of the art for the preparation of organic glasses having UV and HEV light-absorbing properties can be used.

In an embodiment, the UV and/or HEV light-absorbing agent comprises at least one compound selected from: benzotriazole, benzophenone, triazine, oxalanilide and mixtures thereof.

In another embodiment, the UV and/or HEV light-absorbing agent comprises one or more compounds represented by the following formula (i):

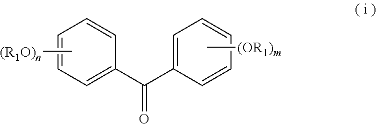

wherein, R₁ indicates a hydrogen atom, or a linear or branched alkyl group having 1 to 20 carbon atoms, a plurality of present R₁'s may be the same or different;
m is an integer of 1 to 5, preferably an integer of 1 to 3, n is an integer of 1 to 5, preferably an integer of 1 to 3, and the sum of m and n is an integer of 2 to 10, preferably an integer of 3 to 6.

In the formula (i), R₁ is preferably a linear or branched alkyl group having 1 to 20 carbon atoms such as a hydrogen atom, a methyl group, an ethyl group, a propyl group, an isopropyl group, a butyl group, an isobutyl group, a sec-butyl group, a tert-butyl group, a pentyl group, a hexyl group, a heptyl group, an octyl group, a 2-ethyl hexyl group, a nonyl group, and a decyl group, and particularly preferably a hydrogen atom, a methyl group, an ethyl group, and a propyl group.

Examples of UV and/or HEV absorbing agent according to formula (i) include: 2,2′,4-trihydroxybenzophenone, 2,2′-dihydroxy-4-methoxybenzophenone, 2,2′-dihydroxy-4-ethoxybenzophenone, 2,2′-dihydroxy-4-n-propoxybenzophenone, 2,2′-dihydroxy-4-isopropoxybenzophenone, 2,2′-dihydroxy-4-n-butoxybenzophenone, 2,2′-dihydroxy-4-t-butoxybenzophenone, 2-hydroxy-4,4′-dimethoxybenzophenone, 2-hydroxy-4,4′-diethoxybenzophenone, 2-hydroxy-4,4′-di-n-propoxybenzophenone, 2-hydroxy-4,4′-diisopropoxybenzophenone, 2-hydroxy-4,4′-di-n-butoxybenzophenone, 2-hydroxy-4,4′-di-t-butoxybenzophenone, 2-hydroxy-4-methoxy-4′-ethoxybenzophenone, 2-hydroxy-4-methoxy-4′-n-propoxybenzophenone, 2-hydroxy-4-methoxy-4′-isopropoxybenzophenone, 2-hydroxy-4-methoxy-4′-n-butoxybenzophenone, 2-hydroxy-4-methoxy-4′-t-butoxybenzophenone, 2-hydroxy-4-ethoxy-4′-methoxybenzophenone, 2-hydroxy-4-ethoxy-n-propoxybenzophenone, 2-hydroxy-4-ethoxy-4′-isopropoxybenzophenone, 2-hydroxy-4-ethoxy-4′-n-butoxybenzophenone, 2-hydroxy-4-ethoxy-4′-t-butoxybenzophenone, 2-hydroxy-4-n-propoxy-4′-methoxybenzophenone, 2-hydroxy-4-n-propoxy-4′-ethoxybenzophenone, 2-hydroxy-4-n-propoxy-4′-isopropoxybenzophenone, 2-hydroxy-4-n-propoxy-4′-n-butoxybenzophenone, 2-hydroxy-4-n-propoxy-4′-t-butoxybenzophenone, 2-hydroxy-4-isopropoxy-4′-methoxybenzophenone, 2-hydroxy-4-isopropoxy-4′-ethoxybenzophenone, 2-hydroxy-4-isopropoxy-4′-n-propoxybenzophenone, 2-hydroxy-4-isopropoxy-4′-n-butoxybenzophenone, 2-hydroxy-isopropoxy-4′-t-butoxybenzophenone, 2-hydroxy-4-n-butoxy-4′-methoxybenzophenone, 2-hydroxy-4-n-butoxy-4′-ethoxybenzophenone, 2-hydroxy-4-n-butoxy-4′-n-propoxybenzophenone, 2-hydroxy-4-n-butoxy-4′-isopropoxybenzophenone, 2-hydroxy-4-n-butoxy-4′-t-butoxybenzophenone, 2-hydroxy-4-t-butoxy-4′-methoxybenzophenone, 2-hydroxy-4-t-butoxy-4′-ethoxybenzophenone, 2-hydroxy-4-t-butoxy-4′-n-propoxybenzophenone, 2-hydroxy-4-t-butoxy-4′-isopropoxybenzophenone, 2-hydroxy-4-t-butoxy-4′-n-butoxybenzophenone, 2,2′,4,4′-tetrahydroxybenzophenone, 2,2′-dihydroxy-4,4′-dimethoxybenzophenone, 2,2′-dihydroxy-4,4′-diethoxybenzophenone, 2,2′-dihydroxy-4,4′-di-n-propoxybenzophenone, 2,2′-dihydroxy-4,4′-di-isopropoxybenzophenone, 2,2′-dihydroxy-4,4′-di-n-butoxybenzophenone, 2,2′-dihydroxy-4,4′-di-t-butoxybenzophenone, 2,2′-dihydroxy-4-methoxy-4′-diethoxybenzophenone, 2,2′-dihydroxy-4-methoxy-4′-n-propoxybenzophenone, 2,2′-dihydroxy-4-methoxy-4′-isopropoxybenzophenone, 2,2′-dihydroxy-4-methoxy-4′-n-butoxybenzophenone, 2,2′-dihydroxy-4-methoxy-4′-t-butoxybenzophenone, 2,2′-dihydroxy-4-ethoxy-4′-n-propoxybenzophenone, 2,2′-dihydroxy-4-ethoxy-4′-isopropoxybenzophenone, 2,2′-dihydroxy-4-ethoxy-4′-n-butoxybenzophenone, 2,2′-dihydroxy-4-ethoxy-4′-t-butoxybenzophenone, 2,2′-dihydroxy-4-n-propoxy-4′-isopropoxybenzophenone, 2,2′-dihydroxy-4-n-propoxy-4′-n-butoxybenzophenone, 2,2′-dihydroxy-4-n-propoxy-4′-t-butoxybenzophenone, 2,2′-dihydroxy-4-isopropoxy-4′-n-butoxybenzophenone, 2,2′-dihydroxy-4-isopropoxy-4′-t-butoxybenzophenone, 2,2′-dihydroxy-4-n-butoxy-4′-t-butoxybenzophenone, 2,2′,4-trimethoxybenzophenone, 2,2′,4-triethoxybenzophenone, 2,2′,4-tri-n-propoxybenzophenone, 2,2′,4-triisopropoxybenzophenone, 2,2′,5-trimethoxybenzophenone, 2,2′,5-triethoxybenzophenone, 2,2′,5-tri-n-propoxybenzophenone, 2,2′,5-triisopropoxybenzophenone, 2,4,4′-trimethoxybenzophenone, 2,4,4′-triethoxybenzophenone, 2,4,4′-tri-n-propoxybenzophenone, 2,4,4′-triisopropoxybenzophenone, 3,4′,5-trimethoxybenzophenone, 3,4′,5-triethoxybenzophenone, 3,4′,5-tri-n-propoxybenzophenone, 3,4′,5-triisopropoxybenzophenone, 2,4-dimethoxy-4′-hydroxybenzophenone, 2,4-diethoxy-4′-hydroxybenzophenone, 2,4-di-n-propoxy-4′-hydroxybenzophenone, 2,4-diisopropoxy-4′-hydroxybenzophenone, 2,2′,4,4′-tetramethoxybenzophenone, 2,2′,4,4′-tetraethoxybenzophenone, 3,3′4,4′-tetramethoxybenzophenone, 3,3′,4,4′-tetraethoxybenzophenone, 2,3,3′,4′-tetramethoxybenzophenone, 2,3,3′,4′-tetraethoxybenzophenone, and the like. Among these, 2,2′-dihydroxy-4-methoxybenzophenone, 2,2′-dihydroxy-4,4′-dimethoxybenzophenone, and 2,2′,4,4′-tetrahydroxybenzophenone are particularly preferable.

The total amount of UV and/or HEV light-absorbing agent in the polymerizable composition is preferably within the range from an amount of 0.05% to 5% by weight, preferably 0.5% to 3% by weight, with respect to the total weight of the polymerizable component.

### Tetraazaporphyrin Dye (C)

Tetraazaporphyrin (TAP) dyes that can be used in the present invention are compounds known in the art and commonly used as organic dyes for the production of organic glass. According to one aspect of the present invention, TAP dyes are used as bleaching agents, namely to correct yellowness caused by the presence of the UV- and/or HEV-absorbers in a polymerizable composition in the presence of peroxydicarbonate ester compounds as polymerization initiators.

According to another aspect of the present invention, TAP dyes are used to impart antiglare properties to the optical material. When used as antiglare additive, it is not essential that the TAP dye yields a colourless optical material, for example if this material has to be subsequently coloured such as in the case of sunglass lenses. Based on the finding of the present invention, TAP dyes can be advantageously used to achieve an antiglare effect by uniformly distributing them into the polymerizable composition compared to the conventional application in the form of a coating in post-curing treatments of the optical material.

In an embodiment, the TAP dye has a main absorption peak between 565 nm and 605 nm in the visible ray absorption spectrum. The absorption peak may be a single peak substantially having no side peaks, but there are frequently cases in which a side peak overlapping with the main peak is observed.

In an embodiment, the TAP dye can be represented by the following formula T1:

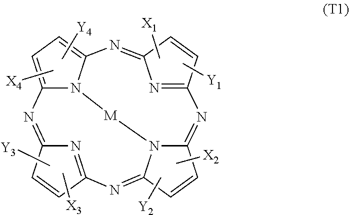

wherein:
   X¹ to X⁴ each individually represents a tertiary saturated alkyl group having 6 or less carbon atoms;
   Y¹ to Y⁴ each individually represents a hydrogen atom, a substituted or unsubstituted aryl group having from 6 to 20 carbon atoms, a substituted or unsubstituted aryloxy group, or a substituted or unsubstituted haloaryl group having from 6 to 20 carbon atoms,
   M represents a divalent metal atom, a trivalent metal atom having one substituent, a tetravalent metal atom having two substituents, or an oxy-metal atom.

In the present specification, the TAP dye represented by the general formula (T1) represents one compound or a mixture of compounds composed of two or more positional isomers. In describing the structure of such a mixture of a plurality of positional isomers, in this specification, for the sake of convenience, one structural formula represented by the general formula (T1) is used.

Examples of tertiary saturated hydrocarbon groups having 6 or less carbon atoms in formula T1 above include: tert-butyl group, 1,1-dimethylpropyl group, 1,1-dimethyl group, butyl group, 1,1-diethylethyl group and a 1,1,2-trimethylpropyl group, preferably tert-butyl group.

The substituents of the aryl group having from 6 to 20 carbon atoms and aryloxy group having from 6 to 20 carbon atoms may be selected from: alkyl group having 1 to 6 carbon atoms, alkoxy group having 1 to 4 carbon atoms or a trifluoromethyl group.

Examples of substituted or unsubstituted aryl group having from 6 to 20 carbon atoms include: phenyl, o-tolyl, p-tolyl, ethyl, p-ethylphenyl group, m-isobutylphenyl group, p-t-butylphenyl group, o-methoxyphenyl group, p-trifluoromethylphenyl group, preferably phenyl.

Examples of substituted or unsubstituted aryloxy groups other than hydrogen atom include: phenoxy group, o-tolyloxy group, p-tolyloxy group, p-ethylphenyloxy group, m-isobutylphenyloxy group and p-t-butylphenyloxy group, o-methoxyphenyloxy group, p-trifluoromethylphenyloxy group, p-methoxyphenyloxy group, p-ethoxyphenyloxy group, p-phenoxyphenoxy group, m-chlorophenyloxy group, p-bromophenyloxy group, preferably phenoxy group.

Examples of haloaryl group having from 6 to 20 carbon atoms include: o-fluorophenyl, p-fluorophenyl, o-bromophenyl, p-bromophenyl, o-chlorophenyl, p-chlorophenyl, preferably o-fluorophenyl and p-fluorophenyl.

Examples of a halogen atom include: chlorine, bromine and fluorine.

In an embodiment, in the above formula T1 M is selected from: Cu, VO, Ni, Pd, Pt and Co.

In an embodiment, the above formula T1 does not include the TAP dye wherein all of Y¹ to Y⁴ are hydrogen atoms.
In another embodiment (T1a), in the above formula T1:
M is a divalent metal selected from Pd or Cu;
X¹ to X⁴ each individually represents a tert-butyl group,
Y¹ to Y⁴ each individually represents a phenyl group substituted with at least one halogen atom, preferably a fluorophenyl group.
   In another embodiment (T1b), in the above formula T1:
M is a divalent metal selected from Cu or VO;
X¹ to X⁴ each individually represents a tert-butyl group,
Y¹ to Y⁴ each individually represents a phenyl group or a phenyloxy group.

In an embodiment, the polymerizable composition comprises only one TAP dye. In certain embodiments, however, the polymerizable composition advantageously includes two or more TAP dyes in order to more precisely adjust the colour hue in the final product.

The total amount of TAP dye in the polymerizable composition is less than 300 ppm, preferably 250 ppm or less, more preferably within the range of from 0.01 ppm to 250 ppm, more preferably from 0.05 ppm to 250 ppm, more preferably from 0.5 ppm to 250 ppm (parts by weight with respect to the weight of the polymerizable composition).

In an embodiment, total amount of TAP dye in the polymerizable composition is within the range of from 1.0 ppm to 50 ppm,

The above described TAP dyes can be prepared according to the synthesis methods known to the person skilled in the art, for example as described in JP2006321925A.

The above described TAP dyes are also commercially available, for example as the PD Series compounds manufactured by YAMAMOTO CHEMICALS, a subsidiary company of Mitsui Chemicals Inc.

### Radical Polymerization Initiator (D)

According to the present invention, the polymerizable composition includes at least one radical polymerization initiator for thermal initiation. The radical initiator is an organic peroxide compound selected from peroxydicarbonate esters.

In an embodiment, the peroxydicarbonate esters are those having the following formula (F1)

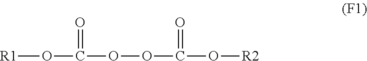

wherein R₁ and R₂, the same or different, are selected from: C₁-C₂₀ alkyl, C₁-C₂₀ alkenyl or C₁-C₂₀ cycloalkyl.

In formula F1, R₁ and R₂ preferably have from 2 to 16 carbon atoms, more preferably from 3 to 7 carbon atoms.

In formula F1, R₁ and R₂ can be linear or branched, and possibly substituted (for example with at least one halogen atom (e.g. Cl or Br) or a NO₂ group)

Examples of R₁ and R₂ groups are: methyl, ethyl, n-propyl, isopropyl, n-butyl, sec-butyl, isobutyl, and hexyl. Examples of peroxydicarbonate esters are: di(2-ethylhexyl) peroxydicarbonate, cyclohexyl peroxydicarbonate, di(cyclohexyl) peroxydicarbonate, di(sec-butyl) peroxydicarbonate and diisopropyl peroxydicarbonate.

The amount of the radical polymerization initiator in the polymerizable composition varies depending on the polymerization conditions, the kind of initiator, the purity of the initiator, the diluent used, and the chemical composition of the polymerizable component and is generally not limited. In an embodiment, the radical polymerization initiator is used in an amount within the range of from 0.1% to 5.0% by weight, preferably 0.5% to 3.5% by weight, with respect to the weight of the polymerizable component. It is also possible to use a combination of two or more kinds of radical polymerization initiator.

### Other Components

The polymerizable composition may also include further additive compounds such as an internal release agent, a resin modifier (e.g. a chain extender, a cross-linking agent, a light stabilizer), an antioxidant, filler, adhesion improver, and the like.

As the internal release agent, for example, it is possible to use an acidic phosphate ester or a nonreactive silicone oil. Examples of acidic phosphate esters include phosphoric monoesters and phosphoric diesters and it is possible to use the above alone or in a mixture of two or more kinds.

Examples of resin modifiers include an olefin compound including an episulfide compound, an alcohol compound, an amine compound, an epoxy compound, an organic acid and an anhydride thereof, a (meth)acrylate compound, and the like.

### Preparation of the Optical Materials

The polymerizable composition for the production of an optical material according to the present invention may be prepared by mixing the following as a batch (step i): (A) the polymerizable component comprising a diallyl compound, (B) the UV and/or HEV light-absorbing agent, (C) the TAP dye and (D) the radical polymerization initiator.

In an embodiment, one or more of the components B, C and D can be used in the form of a masterbatch composition, i.e. they are pre-dispersed in a polymerizable monomer, such as any of the diallyl compounds that can be used as polymerizable component described above, prior to be incorporated into the polymerizable composition. Preferably, the polymerizable monomer of the masterbatch is the same as the polymerizable component of the polymerizable composition.

The mixing of the above components is usually carried out at a temperature of 25 degree C. or lower. From the viewpoint of the pot life of the polymerizable composition, it may be preferable to further lower the temperature.

According to a preferred embodiment, the composition may be stirred until homogeneous and subsequently degassed under reduced pressure and/or filtered before curing.

The polymerizable composition may be casted (step ii) into a casting mould and cured (step iii) by heating at a temperature of from ambient temperature to 90 degree C., preferably from 25 degree c. to 90 degree C., more preferably from 30 to 85 degree C., over a period of time from 2 to 48 hours. According to a preferred embodiment, the thermal cure cycle may last for 5 to 24 hours, more preferably 7 to 22 hours, even more preferably 15 to 20 hours. The curing step can be carried out in conventional apparatus, such as a convection oven.

The curing step is deemed completed when the liquid polymerizable composition has been transformed into a solid optical material suitable for being demolded. Preferably, the end of the curing step can be established by measuring the Rockwell hardness M of the solid polymerized optical material. For example, the curing step can be considered completed when the solid polymerized molded element has a Rockwell hardness M, measured according to ASTM D-785 on a 4 mm-plano lens, that does not vary significantly after a conventional annealing treatment, i.e. after thermally treating the demolded optical material at 110 degree C. for 1 hour; the Rockwell hardness M of the annealed optical material does not vary significantly if its value increases of 3 units at most compared to the Rockwell hardness M value of the demolded optical material before the annealing treatment.

The moulds can be conventional moulds, for example made from two mould pieces and a gasket forming a cavity that defines the shape and dimensions of the final optical material. The mould pieces can be made of glass, metal or plastic.

In an embodiment, at the end of the curing, the polymerized molded element so obtained is extracted from the mould and then heat treated to allow the TAP dye recover at least part of its light-absorbing activity that is lost during the curing.

In an embodiment, the polymerized molded element may be cleaned, for example with water, ethanol or isopropanol, before being heat treated according to step iv of the present invention.

The heat treatment of the polymerized molded element (step iv) is performed at a temperature within the range of from 50 degree C. to 150 degree C., preferably within the range of from 100 degree C. to 140 degree C., even more preferably within the range of from 110 degree C. to 130 degree C.

The duration of the heat treatment is generally within the range of from 30 minutes to 15 hours, preferably from 1 hour to 10 hours, more preferably from 1 hour to 7 hours.

It has been observed that the most appropriate duration of the heat treatment may depend on the amount of TAP dye present in the optical material. For concentrations as low as from 1 to below 5 ppm, a duration of 3 to 10 hours may be sufficient to recover most of the activity of the TAP dye. For concentrations within the range from 5 to 300 ppm, a duration of 30 minutes to 3 hours is more recommendable.

The heat treatment can be carried out for example in a conventional apparatus used in the manufacturing of optical materials, such as a convection oven.

The heat treatment step according to the present invention may also function as an annealing step, when it is carried out on the demolded article. The heat treating of step iv, in fact, allows to neutralize radical species of the polymerization initiator that may still be present in the polymerized molded article and eliminate possible demolding stresses from the polymerized molded articles.

In another embodiment, the post-curing heat treatment is carried out when the polymerized molded element is still in the mould, that is without extracting it from the mould after the curing step. In this embodiment, for example, at the end of the curing step, the mould can be kept inside the curing apparatus (e.g. convection oven) and the temperature of the latter can be adjusted to the desired heat treatment temperature.

The recovery of the light-absorbing activity can be monitored by determining the Yellowness Index (YI) value (measured, for example, according to ASTM D-1925) or the transmittance T % value (i.e. light cut-off) at the main absorption peak of the TAP dye on the polymerized molded element before and after the heat treatment.

In some cases, depending on the specific wavelength of the main absorption peak of the TAP dye, the optical material obtained after the heat treatment may require additional correction in order to achieve a more colour-neutral appearance. In such cases, an additional dye or pigment can be included in the polymerizable composition to shift the colour of the optical material to appear the most neutral possible.

In some cases, it has been observed that the recovery of the light-absorbing activity after heat treatment of the polymerized molded element may be influenced by the exposure of the polymerizable composition to artificial and sunlight radiations prior to being cured.

In such cases, in order to obtain more reproducible results, the polymerizable composition can be advantageously kept shielded from light radiations, both artificial and sunlight, after that the TAP dye has been combined with the radical polymerization initiator and until the curing is started.

In an embodiment, the polymerizable composition is kept unexposed to light radiation, for example by preparing the polymerizable composition in containers made of dark materials which do not allow or substantially reduce the transmission of light radiation into the containers. Alternatively, shielding is achievable, for example, by covering the polymerizable compositions in the filled moulds by means of a physical screen (e.g. a plate) made of a material that reduce or prevents light radiation from penetrating the containers.

Shielding of the polymerizable composition from the light radiation can be done after that the polymerizable composition has been casted into the moulds, for example, by laying on top of the moulds a screen element made of a material that prevents light transmission into the moulds.

In another embodiment, the polymerizable composition may be prevented from being exposed to light radiation by selectively shielding only the light radiation within a certain wavelength range, for example within the range of from 565 nm to 605 nm, preferably from 585 nm to 600 nm. Radiation within this specific range of wavelengths, in fact, seems most responsible for the incomplete recovery of the TAP dye light-absorbing capability.

In an embodiment, this selective shielding of the sunlight can be done by means of an optically transparent screen that allows the transmission of the light radiation except for the desired wavelength(s) to be shielded.

In an embodiment, the screen comprises at least one tetraazaporphyrin dye, more preferably the same tetraazaporphyrin dye that is present in the polymerizable composition to be protected.

The screen may be interposed between the sunlight source (natural sunlight, lamp, etc.) and the container containing the polymerizable composition.

In another embodiment, the polymerizable composition can be prepared in an environment which is illuminated by means of an artificial light source that does not emit radiation within the selected range of wavelengths.

To minimize the adverse effect of the exposure of the polymerizable composition to light radiation prior to being cured, it is also advantageous to carry out the mixing of the polymerizable composition at a temperature below 10 degree C., preferably within the range of from 5 degree C. to 9 degree C.

The method of the present invention allows to prepare an optical material that is clear, namely that has a total light transmittance (T %) equal to or higher than 85%, and that exhibits a UV-cut and/or a HEV-cut along with low haze values. Depending on the characteristic absorption wavelength of the TAP dye, and thus its colour, the optical material can be also color-neutral.

Moreover, since TAP dyes have very selective light-absorption characteristics, the optical material also possess antiglare properties, particularly when the TAP dye used has a main absorption peak within at about 585 nm.

In an embodiment, the optical material has a HEV-cut, measured in accordance with ASTM D 1003, within the range of from 380 nm to 420 nm.

In an embodiment, the optical material has a haze value, measured in accordance with ASTM D 1003, equal to or lower than 1.5%, more preferably equal to or lower than 1.0%, even more preferably equal to or lower than 0.5%.

In an embodiment, the optical material has a refractive index, measured in accordance with ASTM D542, equal to or lower than 1.600, preferably within the range 1.560 to 1.500.

In an embodiment, the optical material has antiglare properties, that is the polymerized optical material has a value of the Transmittance (T %) at the wavelength peak of the TAP dye, measured on a plano lens of 2 mm-thickness, within the range from 80% to 20%, preferably from 70% to 30%, more preferably from 60% to 40%. The optical material of the present invention also exhibit excellent mechanical properties, such as hardness, impact strength and resistance to abrasion.

The optical material of the present invention can be used for a variety of application, particularly as an ophthalmic lens. The ophthalmic lens is herein defined as a lens which is designed to fit a spectacles frame so as to protect the eye and/or correct the sight. Said ophthalmic lens can be an uncorrective ophthalmic lens (also called plano or afocal lens) or a corrective ophthalmic lens. Corrective lens may be a unifocal, a bifocal, a trifocal or a progressive lens.

The optical material may be coated with one or more functional coatings selected from the group consisting of an anti-abrasion coating, an anti-reflection coating, an antifouling coating, an antistatic coating, an anti-fog coating, a polarizing coating, a tinted coating and a photochromic coating.

The invention will now be described in more detail with the following examples, which are given for purely illustrative purposes and which are not intended to limit the scope of the invention in any manner, and with reference to the following figures:

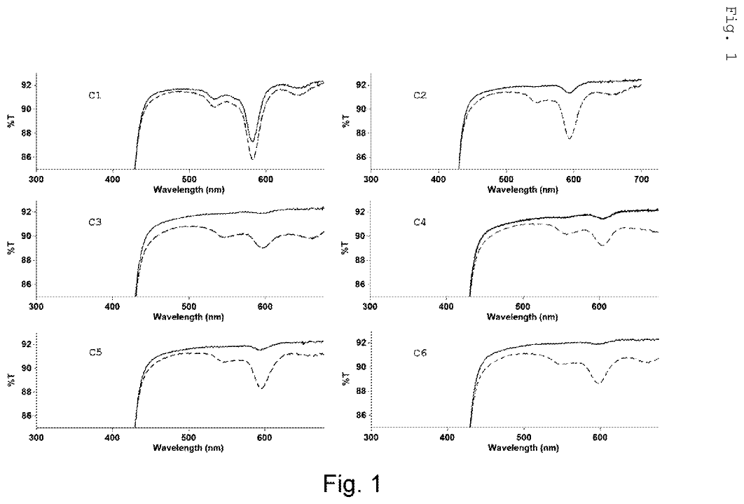

FIG. 1, which depicts the UV Vis spectra in transmittance of optical materials C1 to C6 prepared according to the invention, wherein full lines are the spectra before heat treating the cured compositions and dashed lines are the spectra after heat treating the cured compositions;

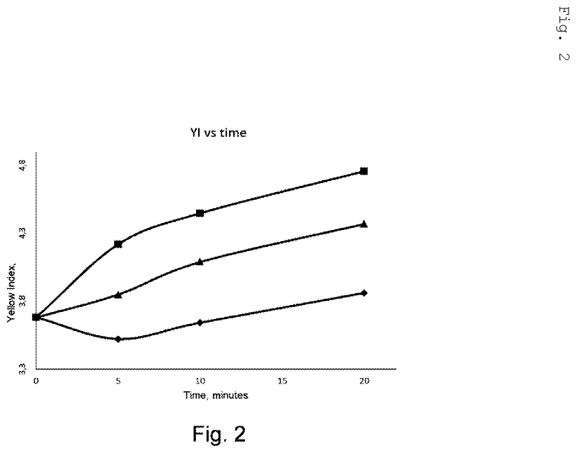

FIG. 2, which depicts the variation of the Yellow Index (ASTM D1925) as a function of the time of exposure to light of the polymerizable composition before curing.

### EXAMPLES

### Characterization Methods

The optical materials were evaluated by means of the following methods.

### Yellowness Index (YI) (ASTM D-1925):

The YI was determined on the optical material in the form of a 4 mm-plano lens with a GretagMacbeth 1500 Plus spectrophotometer taking the standard illuminant C and the observer into account (angle of 2 degree). The YI is defined as: YI=100/Y (1.277X-1.06Z).

Colorimetric coefficients of the lenses of the invention were measured on a 4 mm-plano lens according to the international colorimetric system CIE L* a* b*, i.e. calculated between 380 and 780 nm, taking the standard illuminant D 65 and the observer into account (angle of 2 degree).

### Light Cut-Off Ratio at a Given Wavelength:

The transmittance at a given wavelength (e.g. 400 nm, 405 nm, 410 nm) of the optical material in the form of a flat plate having a thickness of 2 mm was measured with an UV-Visible spectrophotometer Agilent Cary 60. The light cut-off ratio at a given wavelength, for example 400 nm, is defined by the following formula:

Light Cut-off ratio₍₄₀₀₎%=100(%)−Transmittance (%) at 400 nm

### Light Transmittance at a Given Wavelength:

The transmittance at a given wavelength of an optical material in the form of a flat plate having a thickness of 2 mm was measured with an UV-Visible spectrophotometer Agilent Cary 60.

### Total Light Transmittance and Haze Value:

The total light transmittance and haze value of the optical material in the form of a flat plate having a thickness of 2 mm was measured in accordance with ASTM D 1003 with a digital haze meter haze-gard plus manufactured by BYK-Gardner.

### Mechanical Properties—Rockwell Hardness M

The Rockwell Hardness M (ASTM D-785) of the optical material has been evaluated on a 4 mm-thick plano lens.

### Materials

In the Examples, the following compounds were used.

### Polymerizable Component

RAV 755-T, a mixture of an allyl ester compound, an allyl carbonate compound, and compounds having an allyl ester group and an allyl carbonate group, obtained by ester replacement of a mixture of dimethyl terephthalate, allyl alcohol, diallyl carbonate, and diethylene glycol, manufactured by Acomon;
RAV 7AT, aliphatic poly(allyl carbonate) compound of diethylene glycol and pentaerythritol, and oligomers thereof, manufactured by Acomon;
RAV 7AX, aliphatic poly(allyl carbonate) compound of diethylene glycol and pentaerythritol, with higher oligomeric content with respect to RAV 7AT, manufactured by Acomon.

### UV Absorber

BP6 (2,2′-dihydroxy-4,4′-dimethoxybenzophenone, manufactured by MFCI).

### Peroxide Radical Polymerization Initiator

Trigonox ADC-NS30 (registered trademark) by Akzo Nobel; the commercial product contains about 70% by weight of diethylene glycol bis(allyl carbonate) and 30% by weight of a mixture of isopropyl peroxydicarbonates, sec-butyl and isopropyl/sec-butyl.

### TAP Dyes

Tap dyes represented by the general formula (1) were tested:

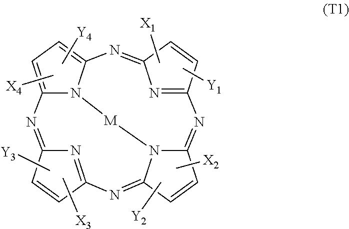

Dye A: TAP of formula (T1) in which: M=Pd; X¹ to X⁴ each individually represents t-butyl; Y¹ to Y⁴ each individually represents fluorophenyl. Main absorption peak at 583 nm;
Dye B: TAP of formula (T1) in which: M=Cu; X¹ to X⁴ each individually represents t-butyl; Y¹ to Y⁴ each individually represents fluorophenyl. Main absorption peak at 594 nm;
Dye C: TAP of formula (T1) in which: M=Cu; X¹ to X⁴ each individually represents t-butyl; Y¹ to Y⁴ each individually represents hydrogen atom. Main absorption peak at 585 nm;
Dye D: TAP of formula (T1) in which: M=VO; X¹ to X⁴ each individually represents t-butyl; Y¹ to Y⁴ each individually represents hydrogen atom. Main absorption peak at 595 nm;
Dye E: TAP of formula (T1) in which: M=Cu; X¹ to X⁴ each individually represents t-butyl; Y¹ to Y⁴ each individually represents phenyl. Main absorption peak at 595 nm;
Dye F: TAP of formula (T1) in which: M=Cu; X¹ to X⁴ each individually represents t-butyl; Y¹ to Y⁴ each individually represents phenoxy. Main absorption peak at 595 nm.

### Example 1

In a first experimental test, TAP dyes were evaluated as bluing agents for an optical material having UV-cut of 400 nm. The prepared polymerizable compositions C1 to C6 had the following chemical composition:
100 parts by weight of the polymerizable component RAV 7AX,
12.4 parts by weight of Trigonox ADC NS30 (peroxydicarbonate initiator),
0.20 parts by weight of BP6 (UV absorber), and
TAP dye (bluing agent) in the amount indicated in Table 1.

For comparison purposes, a polymerizable composition was prepared having the above composition, except for the TAP dye being absent (sample “Ref.”), namely without correcting the yellow colour imparted by the UV absorber.

Before casting, each polymerizable composition was vigorously mixed with a magnetic stirrer, degassed for 30-60 minutes at a pressure below 100 mbar and then filtered on a 0.45 micrometers PTFE membrane (47 mm diameter) before filling the moulds.

Since the dye A demonstrated to be sensitive to the natural light after being mixed with the polymerization initiator, all the compositions containing TAP dye A described herein have been kept shielded from natural light radiations after they were mixed with the polymerization initiator and until they were placed in the oven for curing (i.e. they were prepared inside reactors having dark walls and, after casting the polymerizable composition in the moulds, were covered with a plastic dark screen).

The polymerizable compositions were casted and polymerized by casting in glass moulds in the form of plano lenses having a thickness of 2 mm for the determination of the total transmittance and haze % and 4 mm for the determination of YI and the color coordinates, L*, a* and b*.

The curing step was carried out by means of thermal treatment in a forced-air-circulation oven, with a gradual temperature rise (curing program: 40 degree C.=40 degree C.(3 h)--50 degree C.(7 h)--80 degree C.(9 h)=80(1 h), where “=” means isotherm step and “--” means increasing temperature).

At the end of the curing step, the moulds were opened and the removed polymerized molded elements were subjected to a heat treatment according to the method of the present invention at 130 degree C. for 7 hours in a forced-air-circulation oven.

The YI values, the colorimetric coefficients L* a* b* and the cut-off (T %) at peak wavelength were measured on the optical material before and after the heat treatment. The results are reported in Table 1.

TABLE 1
Polymerized optical material having UV-cut of 400 nm

| Composition n. | C1 | C2 | C3 | C4 | C5 | C6 | Ref. |
|---|---|---|---|---|---|---|---|
| Dye | A | B | C | D | E | F | — |
| (peak λ, nm) | (583) | (594) | (585) | (595) | (595) | (595) | |
| Concentration in | 1.7 | 2.0 | 4 | 4 | 4 | 4 | 0 |
| RAV 7AX (ppm) | | | | | | | |

Data before heat treatment (4 mm plano lenses)

| | | | | | | | |
|---|---|---|---|---|---|---|---|
| YI as cast (4 mm) | 3.79 | 5.95 | 7.52 | 7.79 | 6.61 | 7.09 | 6.72 |

Data after heat treatment (4 mm plano lenses)

| | | | | | | | |
|---|---|---|---|---|---|---|---|
| Y.I. (after | 2.70 | 2.62 | 3.75 | 4.92 | 1.53 | 3.20 | 6.24 |
| heat treatment) | | | | | | | |
| L* | 96.1 | 96.5 | 95.2 | 95.5 | 95.3 | 95.8 | 97.3 |
| a* | −2.06 | −1.78 | −3.17 | −3.37 | −3.80 | −3.34 | −2.32 |
| b* | 2.36 | 1.85 | 3.33 | 4.05 | 2.40 | 3.12 | 4.41 |

Spectroscopic data (2 mm plano lenses - as cast)

| | | | | | | | |
|---|---|---|---|---|---|---|---|
| T % @ λ^{a} | 87.3 | 91.3 | 91.9 | 91.5 | 91.5 | 91.9 | — |

Spectroscopic data (2 mm plano lenses - after thermal treatment)

| | | | | | | | |
|---|---|---|---|---|---|---|---|
| T % @ λ^{a} | 85.8 | 87.6 | 89.7 | 89.8 | 88.3 | 88.7 | — |
| Transmittance % | 91.2 | 91.7 | 91.3 | 91.5 | 91.6 | 91.5 | 93.5 |
| Haze % | 0.16 | 0.15 | 0.14 | 0.15 | 0.14 | 0.13 | 0.13 |

^{a}Transmittance measured at the main absorption peak (“peak λ”) of the dye

The data of Table 1 after the curing step show that in each of the compositions the TAP dye allows to obtain reduced YI values compared to the comparative composition (Ref.) not containing any TAP dye.

The heat treatment carried out on the polymerized molded element after the curing step causes a significant decrease of the YI. Such a decrease demonstrates the occurrence of an improved light-absorbing activity of the TAP dyes.

The optical materials containing the TAP dyes A and B show colour coordinates (YI, a* and b*) significantly better than those of the comparative material. The colour-coordinates values indicate that they exhibit a colour-neutral appearance.

The optical materials containing the TAP dyes D and E show better YI and b* values than the comparative material, which means that they appear less yellow than the comparative material. The a* coordinates are higher than those of the comparative material, indicating that the lenses show a greenish hue.

For all the tested compositions, the final optical material exhibits a complete UV protection, a very low haze value. Moreover, the transmittance (T %) is higher than 89% for all the tested compositions.

The recovery of the light-absorbing activity of the TAP dyes is also inferable by comparing the values of transmittance at the main absorption wavelength of each dyes before and after the heat treatment. As shown in Table 1, after the heat treatment a reduction of the Transmittance values is observed for all the tested samples.

The increase of the TAP dye activity can be appreciated also from FIG. 1 which depicts the UV spectra in transmittance of 2 mm UV400 of the materials C1 to C6 of Table 1 before (full lines) and after (dashed lines) thermal treatment (7 hours at 130 degree C.).

The spectra of FIG. 1 also show that the extent of deactivation and recovery of the light absorbing activity varies with the TAP dye. Presumably, such a variation depends on the chemical structure of the dye, most likely on the metal center of the tetraazaporphyrin compound.

### Example 2

In a second experimental test, the polymerizable compositions having the chemical compositions 1 to 14 listed in Table 2 were prepared following the same procedure described in Example 1.

TABLE 2
Optical materials having UV-cut from 393 nm to 414 nm (concentrations expressed in parts by weight)

| | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Cut off | 393 | 393 | 393 | 393 | 400 | 400 | 400 | 400 | 400 | 405 | 405 | 410 | 410 | 414 |
| (nm) | | | | | | | | | | | | | | |
| Refractive | 1.50 | 1.50 | 1.50 | 1.50 | 1.50 | 1.50 | 1.50 | 1.50 | 1.55 | 1.50 | 1.55 | 1.50 | 1.55 | 1.55 |
| index | | | | | | | | | | | | | | |
| RAV 7AT | 100 | 100 | 90 | — | — | — | — | — | — | 55 | — | — | — | — |
| RAV 7AX | — | — | — | 90 | 80 | 80 | 80 | 80 | — | — | — | — | — | — |
| RAV 755-T | — | — | — | — | — | — | — | — | 100 | — | 100 | — | 100 | 47 |
| ADC NS30 | 12.40 | 12.40 | 12.40 | 12.40 | 12.40 | 12.40 | 12.40 | 12.40 | 11.10 | 12.40 | 11.10 | 12.40 | 11.10 | 11.10 |
| BP6^{a} | 0.10 | 0.10 | — | — | — | — | — | — | 0.17 | — | 0.33 | — | 0.67 | — |
| Dye A, ppm | 1.35 | — | — | — | 1.80 | — | — | — | 2.00 | 3.35 | 4.02 | 6.75 | 6.70 | 7.80 |
| Dye B, ppm | — | 1.80 | — | — | — | 2.25 | — | — | — | — | — | — | — | — |
| Dye E, ppm | — | — | 2.7 | — | — | — | 4.5 | — | — | — | — | — | — | — |
| Dye F, ppm | — | — | — | 2.7 | — | — | — | 4.5 | — | — | — | — | — | — |
| RAV 7AX | — | — | 10.0 | 10.0 | 20 | 20 | 20 | 20 | — | 45 | — | 100 | — | — |
| MBUVA^{b} | | | | | | | | | | | | | | |
| RAV 755-T | — | — | — | — | — | — | — | — | — | — | — | — | — | 53 |
| MBUVA^{c} | | | | | | | | | | | | | | |

^{a}component added in powder form
^{b}RAV 7AX MBUVA = masterbatch containing 1 wt % of BP6 UV absorber in RAV 7AX monomer
^{c}RAV 755-T MBUVA = masterbatch containing 2 wt % of BP6 UV absorber in RAV 755-T monomer

At the end of the curing step, the moulds were opened and the removed polymerized molded elements were subjected to a heat treatment according to the method of the present invention at 130 degree C. for 3 hours or 7 hours in a forced-air-circulation oven.

The optical properties of the optical materials 1 to 14 were measured and the results are reported in Table 3-10. For comparison purposes, a corresponding polymerizable composition was prepared for each of the compositions 1 to 14 in which the TAP dye was absent, namely without correcting the yellow colour.

TABLE 3
Samples 1-4 (UV-cut = 393 nm, R.I. = 1.50)

| | | 1 | 2 | 3 | 4 | Ref. |
|---|---|---|---|---|---|---|
| DYE A, ppm | | 1.35 | — | — | — | — |
| DYE B, ppm | | — | 1.80 | — | — | — |
| DYE E, ppm | | — | — | 2.70 | — | |
| DYE F, ppm | | — | — | — | 3.60 | |
| Y.I. | As cast | 2.32 | 3.60 | 4.38 | 4.90 | — |
| | 3 hs@130° C. | 1.27 | 1.35 | — | — | 3.97 |
| | 7 hs@130° C. | — | — | 1.67 | 2.10 | — |

| | | | | | |
|---|---|---|---|---|---|
| L* | 96.5 | 96.4 | 96.5 | 95.90 | 97.3 |
| a* | −1.34 | −2.05 | −2.17 | −2.09 | −1.48 |
| b* | 1.31 | 1.45 | 1.84 | 1.98 | 2.83 |
| T % @ λ^{a} (nm), 2 mm | 88.5 | 91.5 | 91.5 | 91.8 | — |
| as cast | | | | | |
| T % @ λ^{a} (nm), 2 mm | 87.5 | 88.7 | 88.9 | 89.3 | — |
| post heat treatment | | | | | |
| T %, 2 mm post | 92.0 | 92.0 | 92.1 | 92.1 | 93.6 |
| heat treatment | | | | | |
| Haze %, 2 mm post | 0.14 | 0.15 | 0.15 | 0.14 | 0.12 |
| heat treatment | | | | | |
| Rockwell Hardness, | 96 | 96 | 96 | 96 | 96 |
| M(D785), 4 mm post | | | | | |
| heat treatment | | | | | |

^{a}Transmittance measured at the main absorption peak (“peak λ”) of the dye

TABLE 4
Samples 5-8 (UV-cut = 400 nm, R.I. = 1.50)

| | | 5 | 6 | 7 | 8 | Ref. |
|---|---|---|---|---|---|---|
| DYE A, ppm | | 1.80 | — | — | — | — |
| DYE B, ppm | | — | 2.25 | — | — | — |
| DYE E, ppm | | — | — | 4.50 | — | — |
| DYE F, ppm | | — | — | — | 4.50 | — |
| Y.I | As cast | 3.46 | 5.95 | 6.61 | 7.09 | — |
| | 3 hs@130° C. | — | — | — | — | 6.24 |
| | 7 hs@130° C. | 2.46 | 2.62 | 1.53 | 3.20 | — |

| | | | | | |
|---|---|---|---|---|---|
| L* | 95.8 | 96.0 | 95.3 | 95.8 | 97.3 |
| a* | −2.12 | −3.21 | −3.80 | −3.34 | −2.32 |
| b* | 2.38 | 2.76 | 2.40 | 3.12 | 4.41 |
| T % @ λ^{a} (nm), 2 mm | 87.8 | 91.3 | 91.5 | 91.9 | — |
| as cast | | | | | |
| T % @ λ^{a} (nm), 2 mm | 86.7 | 87.6 | 88.3 | 88.7 | — |
| post heat treatment | | | | | |
| T % (2 mm) | 91.6 | 91.7 | 91.1 | 91.5 | 93.5 |
| Haze % (2 mm) | 0.14 | 0.15 | 0.14 | 0.15 | 0.13 |
| Rockwell Hardness, | 95 | 95 | 95 | 94 | 95 |
| M(D785), 4 mm post | | | | | |
| heat treatment | | | | | |

^{a}Transmittance measured at the main absorption peak (“peak λ”) of the dye

TABLE 5
Sample 9 (UV-cut = 400 nm, R.I. = 1.55)

| | | 9 | Ref. |
|---|---|---|---|
| DYE A, ppm | | 2.00 | — |
| Y.I. | As cast | 3.50 | — |
| | 3 hs@130° C. | 2.92 | 7.17 |
| | 7 hs@130° C. | — | — |

| | | |
|---|---|---|
| L* | 95.4 | 96.8 |
| a* | −2.57 | −2.68 |
| b* | 2.65 | 5.04 |
| T % @ λ^{a} (nm), 2 mm as cast | 84.9 | — |
| T % @ λ^{a} (nm), 2 mm post heat treatment | 84.2 | — |
| T % (2 mm) | 90.1 | 92.6 |
| Haze % (2 mm) | 0.18 | 0.14 |
| Rockwell Hardness, M(D785), 4 mm post | 107 | 107 |
| heat treatment | | |

^{a}Transmittance measured at the main absorption peak (“peak λ”) of the dye

TABLE 6
Sample 10 (UV-cut = 405 nm, R.I. = 1.50)

| | | 10 | Ref. |
|---|---|---|---|
| DYE A, ppm | | 3.35 | — |
| Y.I | As cast | 4.52 | — |
| | 3 hs@130° C. | 3.95 | 10.84 |
| | 7 hs@130° C. | — | — |

| | | |
|---|---|---|
| L* | 94.4 | 97.2 |
| a* | −3.30 | −3.79 |
| b* | 3.38 | 7.51 |
| T % @ λ^{a} (nm), 2 mm as cast | 79.8 | — |
| T % @ λ^{a} (nm), 2 mm post heat treatment | 77.6 | — |
| T % (2 mm) | 89.3 | 93.3 |
| Haze % (2 mm) | 0.15 | 0.15 |
| Rockwell Hardness, M(D785), 4 mm post | 92-94 | 92-94 |
| heat treatment | | |

^{a}Transmittance measured at the main absorption peak (“peak λ”) of the dye

TABLE 7
Sample 11 (UV-cut = 405 nm, R.I. = 1.55)

| | | 11 | Ref. |
|---|---|---|---|
| DYE A, ppm | | 4.02 | — |
| Y.I. | As cast | 4.52 | — |
| | 3 hs@130° C. | 2.77 | 11.14 |
| | 7 hs@130° C. | — | — |

| | | |
|---|---|---|
| L* | 93.8 | 97.14 |
| a* | −3.72 | −4.58 |
| b* | 2.95 | 9.53 |
| T % @ λ^{a} (nm), 2 mm as cast | 76.5 | — |
| T % @ λ^{a} (nm), 2 mm post heat treatment | 75.0 | — |
| T % (2 mm) | 88.5 | 92.5 |
| Haze % (2 mm) | 0.19 | 0.20 |
| Rockwell Hardness, M(D785), 4 mm post | 107 | 107 |
| heat treatment | | |

^{a}Transmittance measured at the main absorption peak (“peak λ”) of the dye

TABLE 8
Sample 12 (UV-cut = 410 nm, R.I. = 1.50)

| | | 12 | Ref. |
|---|---|---|---|
| DYE A, ppm | | 6.75 | — |
| Y.I | As cast | 4.93 | — |
| | 3 hs@130° C. | 5.10 | 18.40 |
| | 7 hs@130° C. | — | — |

| | | |
|---|---|---|
| L* | 90.3 | 97.0 |
| a* | −4.66 | −5.84 |
| b* | 3.38 | 12.64 |
| T % @ λ^{a} (nm), 2 mm as cast | 68.2 | — |
| T % @ λ^{a} (nm), 2 mm post heat treatment | 65.8 | — |
| T % (2 mm) | 85.2 | 92.9 |
| Haze % (2 mm) | 0.16 | 0.15 |
| Rockwell Hardness, M(D785), 4 mm post | 92 | 91 |
| heat treatment | | |

^{a}Transmittance measured at the main absorption peak (“peak λ”) of the dye

TABLE 9
Sample 13 (UV-cut = 410 nm, R.I. = 1.55)

| | | 13 | Ref. |
|---|---|---|---|
| DYE A, ppm | | 6.70 | — |
| Y.I | As cast | 4.35 | — |
| | 3 hs@130° C. | 4.02 | 15.83 |
| | 7 hs@130° C. | — | — |

| | | |
|---|---|---|
| L* | | 96.93 |
| a* | | −6.15 |
| b* | | 13.43 |
| T % @ λ^{a} (nm), 2 mm as cast | 69.2 | — |
| T % @ λ^{a} (nm), 2 mm post heat treatment | 67.9 | — |
| T % (2 mm) | 84.6 | 92.3 |
| Haze % (2 mm) | 0.15 | 0.16 |
| Rockwell Hardness, M(D785), 4 mm post | 106 | 106 |
| heat treatment | | |

^{a}Transmittance measured at the main absorption peak (“peak λ”) of the dye

TABLE 10
Sample 14 (UV-cut = 414 nm, R.I. = 1.55)

| | | 14 | Ref. |
|---|---|---|---|
| DYE A, ppm | | 7.80 | — |
| Y.I | As cast | 5.81 | — |
| | 3 hs@130° C. | 5.90 | 20.61 |
| | 7 hs@130° C. | — | — |

| | | |
|---|---|---|
| L* | 90.1 | 96.81 |
| a* | −6.08 | −7.24 |
| b* | 5.21 | 16.61 |
| T % @ λ^{a} (nm), 2 mm as cast | 60.8 | — |
| T % @ λ^{a} (nm), 2 mm post heat treatment | 58.9 | — |
| T % (2 mm) | 83.4 | 92.0 |
| Haze % (2 mm) | 0.18 | 0.20 |
| Rockwell Hardness, M(D785), 4 mm post | 106 | 106 |
| heat treatment | | |

^{a}Transmittance measured at the main absorption peak (“peak λ”) of the dye

The above data shows that TAP dyes can be used for the preparation of optical materials polymerized by means of peroxydicarbonate compounds as polymerization initiators to obtain optical materials that are highly transparent (total T % higher than 85%) and have very low level of haze (lower than 0.2%). Additionally, as indicated by the values of a* and b* are, they have a substantially color-neutral appearance.

### Example 3

Samples 15 to 18 were prepared to assess the possibility of producing lenses having an antiglare effect by incorporating TAP dyes in the mass of the polymerizable compositions.

The compositions of samples 15 to 18 are listed in Table 11.

TABLE 11
Samples 15-18 Optical materials having antiglare effect and UV/HEV
cut ratios (concentrations expressed in parts by weight)

| | 15 | 16 | 17 | 18 |
|---|---|---|---|---|
| Cut off (nm) | 400 | 400 | 413 | 413 |
| Refractive index | 1.50 | 1.50 | 1.50 | 1.50 |
| RAV 7AT | 100.00 | 100.00 | — | — |
| RAV 7AX | — | — | — | — |
| RAV 755-T | — | — | — | — |
| ADC NS30 | 12.40 | 12.40 | 12.40 | 12.40 |
| BP6^{a} | 0.10 | 0.10 | 0.34 | 0.34 |
| Dye A, ppm | 13.50 | — | 13.50 | — |
| Dye B, ppm | — | 16.90 | — | 16.90 |
| RAV 7AX MBUVA^{b} | — | — | 100.00 | 100.00 |
| RAV 755-T MBUVA^{c} | — | — | — | — |

^{a}component added in powder form
^{b}RAV 7AX MBUVA = masterbatch containing 1 wt % of BP6 UV absorber in RAV 7AX monomer
^{c}RAV 755-T MBUVA = masterbatch containing 2 wt % of BP6 UV absorber in RAV 755-T monomer.

The main optical properties of the optical materials 14 to 18 were measured and the results are reported in Tables 12-13

TABLE 12
Samples 15-16 (UV-cut = 400 nm, R.I. = 1.50)

| | | 15 | 16 |
|---|---|---|---|
| DYE A, ppm | | 13.50 | — |
| DYE B, ppm | | — | 16.90 |
| Y.I. | As cast | 1.39 | 4.16 |
| | 3 hs@130° C. | 0.70 | — |
| | 7 hs@130° C. | — | 7.23 |

| | | |
|---|---|---|
| T % @ λ^{a} (nm), 2 mm as cast | 44.6 | 85.5 |
| T % @ λ^{a} (nm), 2 mm post heat treatment | 41.3 | 59.0 |
| T % (2 mm) | 76.3 | 82.0 |
| Haze % (2 mm) | 0.14 | 0.14 |
| Rockwell Hardness, M(D785), 4 mm post | 95 | 94 |
| heat treatment | | |

^{a}Transmittance measured at the main absorption peak (“peak λ”) of the dye

TABLE 13
Samples 17-18 (UV-cut = 413 nm, R.I. = 1.50)

| | | 17 | 18 |
|---|---|---|---|
| DYE A, ppm | | 13.50 | — |
| DYE B, ppm | | — | 16.90 |
| Y.I. | As cast | −0.14 | 13.0 |
| | 3 hs@130° C. | 2.60 | — |
| | 7 hs@130° C. | — | 5.40 |

| | | |
|---|---|---|
| T % @ λ^{a} (nm), 2 mm as cast | 47.8 | 81.9 |
| T % @ λ^{a} (nm), 2 mm post heat treatment | 45.1 | 59.2 |
| T % (2 mm) | 77.8 | 82.0 |
| Haze % (2 mm) | 0.15 | 0.14 |
| Rockwell Hardness, M(D785), 4 mm post | 91 | 91 |
| heat treatment | | |

^{a}Transmittance measured at the main absorption peak (“peak λ”) of the dye

It is noted that sample 14 is also an optical material having antiglare properties.

### Example 4

TAP dye A resulted sensitive to natural light. In fact, after the addition of the initiator to the polymerizable composition, the polymerizable compositions containing this dye showed a color change upon exposure to direct light, which also influenced the YI of the cured polymer lenses. This behaviour of dye A has been therefore further investigated as follows.

A batch of the polymerizable composition C1 of Table 1 containing TAP dye A was casted in a series of glass moulds. The moulds were then exposed to light under three different conditions and for different time periods before being thermally cured.

The exposure conditions were:
A. laboratory artificial light emitted by neon lamps, namely the typical conditions in lens manufacturing sites;
B. outdoor light (sunlight spectrum);
C. in the absence of light by protecting the moulds by means of a cardboard plate (thickness 4.0 mm)

The exposure times were: 0 minutes, 5 minutes, 10 minutes, and 20 minutes. Table 14 below lists the YI values measured on the polymerized optical material for each sample.

TABLE 14

YI*

| | | A | B | C |
|---|---|---|---|---|
| 0 min | as cast | 3.68 | 3.68 | 3.68 |
| | after heat treatment* | 2.71 | 2.72 | 2.70 |
| 5 min | as cast | 3.85 | 4.22 | 3.52 |
| | after heat treatment* | 2.82 | 3.12 | 2.65 |
| 10 min | as cast | 4.09 | 4.45 | 3.64 |
| | after heat treatment* | 3.20 | 3.50 | 2.72 |
| 20 min | as cast | 4.37 | 4.76 | 3.86 |
| | after heat treatment* | 3.40 | 3.65 | 2.75 |

*7 hours at 130° C.

As shown by the results of Table 14, the same YI was obtained when the polymerizable compositions were placed in the oven immediately after casting (zero minutes), while a deterioration of the YI was observed for all the compositions after exposure to either artificial or natural light (columns A and B). The results of Table 14 are reported in FIG. 2, wherein the values of column A are reported as triangles, the values of column B are reported as squares and the values of column C are reported as diamonds.

Further, the TAP dye light-absorbing activity was not totally recovered after the post-curing heat treatment and, in addition, a significant Yellow Index difference between the first and the last casted lens of each series was observed. This behaviour may represent a serious problem in a lens manufacturing process, where typically the filled moulds are left on open trays and exposed to the light for a certain time before being cured, as the light sensitivity of the dye may lead to a lack of color reproducibility among the lenses of the same casting lot. This drawback, however, can be easily and cheaply solved by using a physical barrier, such as a cardboard screen (column C), which prevents the polymerizable composition in the filled moulds from being exposed to light.

An alternative effective solution is represented by the use of screens made of polymeric materials containing light absorbing agent capable of reducing light radiation from penetrating the moulds (light filters).

Light filters were prepared by polymerizing the RAV 7AX polymerizable component after incorporating different amounts (i.e. 20 ppm, 50 ppm and 75 ppm) of the TAP A dye in order to impart a specific shielding ability at the peak wavelength of the TAP dye A to the final cured material.

The light filters were obtained in the form of flat plates having 4 mm-thickness.

The light filters were tested to determine:
the specific Transmittance at the peak wavelength of the dye A (583 nm);
the Luminance (or Lightness) L* (ranging from dark black L*=0 to the bright white L*=100), measured by means of a colorimeter Gretag Color i5 according to EN ISO 11664—part 4.

The light filters were placed on top of the moulds after having filled them with the polymerizable composition C1 of Table 1. After 20 minutes, the filled moulds were placed in the oven (without the screen) for curing the polymerizable compositions according to the curing program described in Example 1. The results of the characterization of the polymerized materials so obtained are reported in Table 15 below.

TABLE 15

| | Ref | I | II | III |
|---|---|---|---|---|
| Filter type | cardboard | RAV 7AX | RAV 7AX | RAV 7AX |
| | | @20 ppm A | @50 ppm A | @75 ppm A |
| Filter T % @ | — | 20.5 | 1.2 | 0.2 |
| 583 nm | | | | |
| Filter L* | — | 57.4 | 28.0 | 19 |
| Data before | | | | |
| YI as cast | 3.79 | 4.32 | 3.95 | 3.72 |
| (4 mm) | | | | |
| Data after | | | | |
| Y.I. (after | 2.70 | 3.20 | 2.89 | 2.80 |
| heat treatment) | | | | |

The use of the polymeric light filters, particularly samples II and III, allowed to achieve light shielding of the polymerizable composition to a comparable extent of that of the cardboard material.

1. Method for manufacturing an optical material comprising the following steps:
i) mixing:
A. at least one polymerizable component comprising at least one diallyl compound,
B. at least one UV and/or HEV light-absorbing agent,
C. at least one tetraazaporphyrin dye,
D. at least one peroxydicarbonate esters as radical polymerization initiator,
to obtain a polymerizable composition;
ii) casting the polymerizable composition in at least one mould;
iii) curing the polymerizable composition to obtain a solid polymerized molded element and extracting the solid polymerized molded element from the mould;
iv) heat treating the solid polymerized molded element at a temperature within the range of from 50 degree C. to 150 degree C. to obtain the optical material.

2. The method according to claim 1,
wherein in step iv the solid polymerized moulded element is heat treated at a temperature within the range of from 110 degree C. to 150 degree C.

3. The method according to claim 1,
wherein in step i the polymerizable composition contains the tetraazaporphyrin dye in an amount of less than 300 ppm.

4. The method according to claim 1,
wherein the visible absorption spectrum of the tetraazaporphyrin dye has a main absorption peak between 565 nm and 605 nm.

5. The method according to claim 1,
wherein in step iv the solid polymerized moulded element is heat treated for a time within the range from 30 minutes to 15 hours, preferably from 1 hour to 10 hours, more preferably from 1 hour to 7 hours.

6. The method according to claim 1,
wherein at least after the step ii and before the step iii the polymerizable composition is shielded from light radiation, preferably at least the light radiation having wavelength within range from 565 nm to 605 nm.

7. The method according to claim 6,
wherein the casted polymerizable composition is shielded from light radiation by means of a screen capable of absorbing light radiation, preferably at least the light radiation having wavelength within range from 565 nm to 605 nm.

8. The method according to claim 7,
wherein the screen comprises at least one tetraazaporphyrin dye, preferably one tetraazaporphyrin dye identical to the tetraazaporphyrin dye of the polymerizable composition.

9. The method according to claim 1,
wherein the mixing step i is carried out at a temperature below 10 degree C.

10. The method according to claim 1,
wherein the tetraazaporphyrin dye has the following formula T1 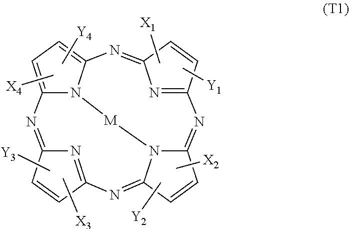
wherein:
X¹ to X⁴ each individually represents a tertiary saturated alkyl group having 6 or less carbon atoms;
Y¹ to Y⁴ each individually represents a hydrogen atom, a substituted or unsubstituted aryl group having from 6 to 20 carbon atoms, a substituted or unsubstituted aryloxy group, or a substituted or unsubstituted haloaryl group having from 6 to 20 carbon atoms,
M represents a divalent metal atom, a trivalent metal atom having one substituent, a tetravalent metal atom having two substituents, or an oxy-metal atom.

11. The method according to claim 10,
wherein in the formula T1 M is selected from: Cu, VO, Ni, Pd, Pt and Co.

12. The method according to claim 11,
wherein in the formula T1 Y¹ to Y⁴ each individually represents a phenyl group substituted with at least one halogen atom, preferably a fluorophenyl group.

13. The method according to claim 10,
wherein in the formula T1:
M is a divalent metal selected from Pd or Cu;
X¹ to X⁴ each individually represents a tert-butyl group,
Y¹ to Y⁴ each individually represents a phenyl group substituted with at least one halogen atom, preferably a fluorophenyl group.

14. The method according to claim 11,
wherein in the formula T1:
M is a divalent metal selected from Cu or VO;
X¹ to X⁴ each individually represents a tert-butyl group,
Y¹ to Y⁴ each individually represents a phenyl group or a phenyloxy group.

15. A polymerizable liquid composition for the manufacturing of an optical material comprising:
A. at least one polymerizable component comprising at least one diallyl compound,
B. at least one UV and/or HEV light-absorbing agent,
C. at least one tetraazaporphyrin dye,
D. at least one peroxydicarbonate ester as radical polymerization initiator,
wherein the tetraazaporphyrin dye has the following formula T1 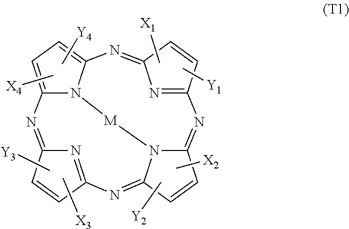
wherein:
X¹ to X⁴ each individually represents a tertiary saturated alkyl group having 6 or less carbon atoms;
Y¹ to Y⁴ each individually represents a hydrogen atom, a substituted or unsubstituted aryl group having from 6 to 20 carbon atoms, a substituted or unsubstituted aryloxy group, or a substituted or unsubstituted haloaryl group having from 6 to 20 carbon atoms;
M represents a divalent metal atom, a trivalent metal atom having one substituent, a tetravalent metal atom having two substituents, or an oxy-metal atom; and
wherein the tetraazaporphyrin dye is present in an amount of less than 300 ppm.

16. The composition according to claim 15,
wherein in the formula T1 M is selected from: Cu, VO, Ni, Pd, Pt and Co.

17. The composition according to claim 16,
wherein in the formula T1 Y¹ to Y⁴ each individually represents a phenyl group substituted with at least one halogen atom, preferably a fluorophenyl group.

18. The composition according to claim 16,
wherein in the formula T1:
M is a divalent metal selected from Pd or Cu;
X¹ to X⁴ each individually represents a tert-butyl group,
Y¹ to Y⁴ each individually represents a phenyl group substituted with a halogen atom, preferably a fluorophenyl group.

19. The composition according to claim 18,
wherein in the formula T1:
M is a divalent metal selected from Cu or VO;
X¹ to X⁴ each individually represents a tert-butyl group,
Y¹ to Y⁴ each individually represents a phenyl group or a phenyloxy group.

20. The composition according to claim 16,
wherein the tetraazaporphyrin dye is present in an amount within less than 300 ppm, preferably within the range from 250 ppm or less, more preferably from 0.01 ppm to 250 ppm, more preferably from 0.05 ppm to 250 ppm, more preferably from 0.5 ppm to 250 ppm, more preferably from 1.0 ppm to 50 ppm.

21. An optical material obtained by the method according to claim 1.

22. An ophthalmic lens comprising the optical material according to claim 21.
